(19) United States
(12) Patent Application Publication
(10) Pub. No.: US 2011/0051721 A1
(43) Pub. Date: Mar. 3, 2011

(54) REDUNDANCY AND WIRELESS SWITCHOVER IN POWERLINE COMMUNICATION SYSTEMS

(75) Inventors: William Jay Brothwell, Raymond, NH (US); Norm Brown, Sandown, NH (US); Thomas Daly, Natick, MA (US); Jacob Farrell, Tewksbury, MA (US); Greg Rybinski, Rutland, MA (US); Nachum Sadan, Carlisle, MA (US)

(73) Assignee: AMPERION INC., Lowell, MA (US)

(21) Appl. No.: 12/440,076

(22) PCT Filed: Sep. 8, 2006
(86) PCT No.: PCT/US06/35170

§ 371 Date: Nov. 17, 2010

(51) Int. Cl. H04L 12/66

(52) U.S. Cl. 370/353

(57) ABSTRACT

The present invention discloses a system and method to use powerline and wireless communications for delivery of data and voice messages over IP (Internet Protocol). In order to achieve high reliability in communication service over powerline, wireless network is used as a redundant network to switch over in case of failover. The invention provides an integrated algorithm that provides seamless switching between powerline and wireless communication methods in real time.

### FIELD OF THE INVENTION

The present invention relates to communications over electrical powerlines using one or more communication technology.

### BACKGROUND OF THE INVENTION

Powerline communication allows transmission of data and voice over the existing powerline network. The data and voice communications systems including wireless and powerlines require very high availability rates to facilitate minimum interruptions to the communication. The telecommunications industry uses the “five nines” 99.999% rate as the criteria for network availability.

However, powerline and wireless, both being a non predictable medium, and highly susceptible to RF interference, are unable to reach that level of high availability without having built-in redundancy and failover.

Communications using powerline medium require a mechanism to facilitate minimum interruptions and hence enhance data and voice communication.

### SUMMARY OF THE INVENTION

Accordingly, the present invention provides a method and system for communications over electrical powerlines where two communication technologies are used. The redundant communication methods used in the invention provides higher network availability between the nodes in a network. The invention uses a software algorithm to switch between a point to point powerline communication link and a point to point wireless link.

The invention uses two communication technologies, wireless and powerline communications, for delivery of data and voice services over IP (Internet Protocol). Specifically, the invention makes use of an integrated algorithm that provides seamless switching between the two communications methods in real time. The switching between wireless and powerline communications is used for redundancy and failover capabilities.

The software algorithm monitors the state of the powerline communications interface and switches to a wireless link when it crosses below a pre-configured threshold level. The same algorithm continues to monitor the state of the powerline communications interface and switches back from the wireless link when another pre-configured threshold level is crossed.

This switching algorithm provides a built-in failover capability, protecting the system against temporary noise events that impede the powerline signal and bring down the powerline communication link.

### BRIEF DESCRIPTION OF DRAWINGS

The present invention is described with reference to the accompanying drawings, where:

FIG. 1 shows a Powerline/Wireless network block diagram

FIG. 2 shows a generic Powerline/Wireless system node block diagram

FIG. 3 shows a second Powerline/Wireless node block diagram

FIG. 4 is a switcher flow chart

### DETAILED DESCRIPTION

### Definitions

The definitions used to explain the invention are provided below:
STP software is a computer readable software.
OK represents positive response to the condition being checked.
NOK represents negative response to the condition being checked.
Wake Up represents activation of the component from its given state.
LONG represents a pre-configured duration as the maximum duration of time allotted for the system to be in a specific state.
MAX represents a pre-configured number as the maximum number of times a process can be attempted.
Sleep mode indicates that the Watch dog timer is in sleep mode
CU/WD represents Control Unit Watch Dog
Reboot represents the resetting of the powerline modem and reinitializing the software

The present invention comprises of a method and system for communications wherein electrical powerlines and wireless communication media are used. The invention facilitates the usage of wireless communication medium as a failover option when the powerline communication crosses below a pre-configured threshold.

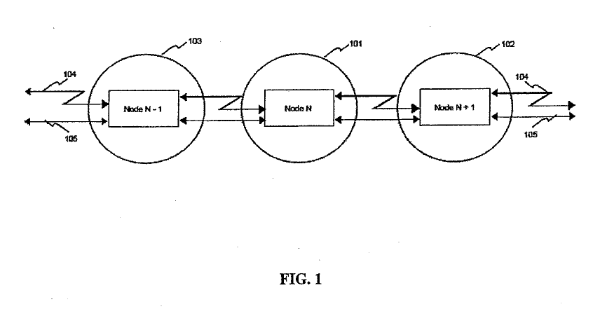

The invention uses two communication technologies, wireless and powerline communications, for delivery of data and voice services over IP (Internet Protocol). FIG. 1 illustrates a typical network segment configuration with nodes where each of the nodes in the network is equipped with one or two powerline modem interfaces and a single or dual wireless radio. In the figure, Node 101 communicates with upstream neighbor (US) 103 and Downstream Neighbor (DS) 102 using the powerline communication medium 105; the invention provides wireless as a failover communication medium 104; the circle in the figure represents the wireless cell coverage area for servicing wireless clients.

The invention makes use of an integrated algorithm that provides seamless switching between the two communications methods in real time. The invention comprises of a software algorithm that applies to any point to point communications over powerline, using wireless transmission as an alternate communication method. The switching between wireless and powerline communications is used for redundancy and failover capabilities.

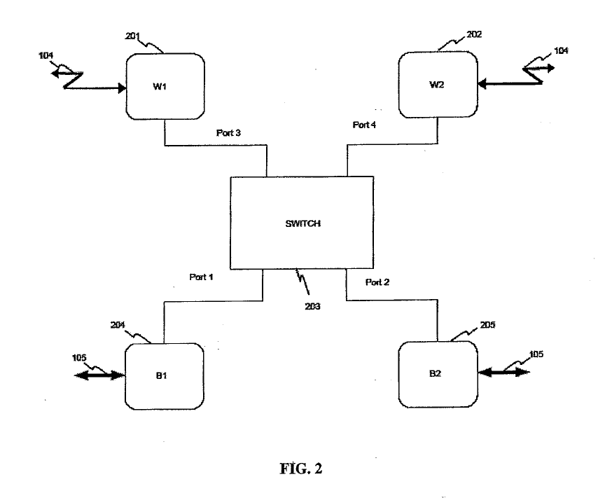

FIG. 2 shows a generic Powerline/Wireless system node block diagram. Further, FIG. 2 shows an implementation of switching between the powerline and wireless interfaces using the Spanning Tree Protocol (STP). There are two powerline modem interfaces for upstream and downstream powerline communications, represented by blocks B1 204 and B2 205 in the figure, are connected to the Switch 203 by the Ethernet ports, port 1 and port 2 respectively. The two wireless interfaces for upstream and downstream communications represented by blocks W1 201 and W2 202 in the figure are connected to the switch by the Ethernet ports, port 3 and port 4 respectively. The node communicates with its neighbors using the powerline communication medium 105, the invention further provides wireless as a failover communication medium 104.

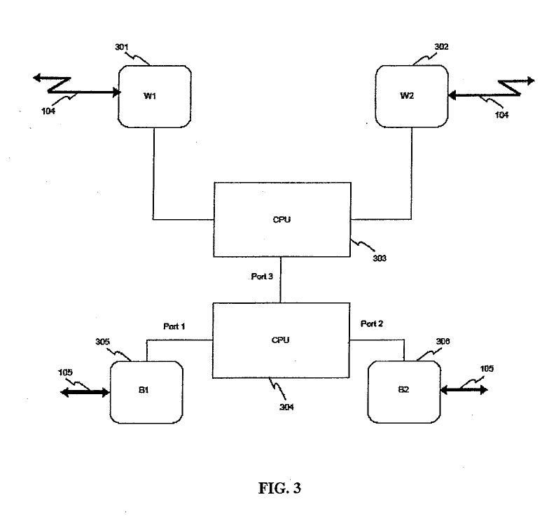

FIG. 3 shows a second Powerline/Wireless node block diagram. Further, FIG. 3 shows a second implementation of the said switching where one or more wireless radio W1 301 and W2 302 are connected to a CPU motherboard 303 and through the motherboard to port 3 of the Ethernet switch 304. The powerline modems represented by blocks B1 305 and B2 306 in the figure are connected to the switch 304 by the Ethernet ports, port 1 and port 2. The node communicates with its neighbors using the powerline communication medium 105, the invention further provides wireless as a failover communication medium 104.

In the above implementations of the invention, each port is assigned an initial cost (weight) by the software. The cost is used by the STP software to switch between interfaces connected to the Ethernet switch. The said interfaces according to the invention are the powerline interface and the wireless interface. The STP algorithm will always select the lowest cost path through the switch, and block all higher cost paths.

In the said implementation, the initial cost values for the powerline interfaces are lower than the wireless interfaces to enable primary communications via powerline and secondary communications over wireless wherein the wireless communication protocol includes but is not limited to WDS, WiMAX (802.16, 802.16e), and WiFi (802.11a, 802.11b, 802.11g, 802.11n).

The state of the powerline medium is measured in bit per carrier (BPC) or bit per symbol values (BPS) and is bounded by low and high threshold markers. The low and high threshold levels are pre-configured by the system operator.

The condition for switching between the two said media is achieved by the STP software by measuring the state of the powerline as described hereinabove. Pre-configured thresholds are used to trigger the switching to enable the communication to be maintained wherein the thresholds are low and high.

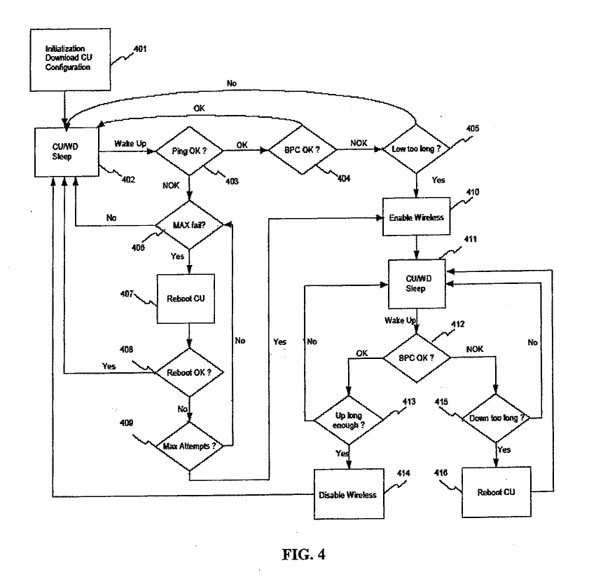

FIG. 4 illustrates an embodiment wherein the methodical steps and the conditions that the STP software uses to determine the switching between the communication channels are described. The figure explains the implementation of switching between powerline and wireless communication medium nodes wherein block diagrams of the powerline and wireless radio nodes for two of the implementations are provided by FIG. 2 and FIG. 3.

The initialization of the system involves the downloading of the conditioning unit (CU) configuration 401. The status of the CU/WD is set to sleep 402 after the initialization.

The CU/WD in the sleep mode 402 is activated as shown by Wake up in the figure.

### Powerline Network Available

The network availability is checked by using the ping utility 403. If the availability of the network is verified by the ping utility as indicated by OK in the figure, the status of BPC is checked 404 by the STP software wherein it is used as a measurement of the state of the powerline medium as explained hereinabove.

If the state of the BPC is certified to be OK by the STP software wherein the BPC number is above the lowest threshold of acceptable powerline communications where the threshold is pre-configured as described hereinabove, the state of the CU/WD is set to sleep 402.

If the state of the powerline is certified to be NOK by the STP software wherein the BPC number is below the lowest threshold of acceptable powerline communications where the threshold is pre-configured as described hereinabove, the STP software checks the duration for which the powerline has been in the said state 405 wherein the state is measured by the number of BPC. If the duration of the said state of powerline communication is not equal to or has not exceeded the LONG duration, the CU/WD is configured to be in sleep mode 402. If the powerline has been in the said state for a duration equal to or exceeded the LONG duration, the secondary communication medium, wireless is enabled 410. The said low BPC is an indication of a noise event that is interfering with the powerline signal and disrupting communication.

### Network Unavailable

The network availability is checked by using the ping utility 403. If the availability of the program is not verified by the ping utility, as indicated by NOK in the figure, the number of attempts to verify the network availability as mentioned above is checked. If the number of attempts is not equal to or has not exceeded the MAX number, the status of CU/WD is configured to be in sleep mode 402.

If the number of said attempts exceeds MAX, the CU is Rebooted 407. The STP software checks the status of the said Reboot, if the Reboot is certified as OK, the status of CU/WD is configured to be in sleep mode 402.

If the CU is not rebooted properly, the number of attempts to perform the said Reboot is checked against the maximum number of attempts permissible by the STP software 409. If the number of attempts to reboot is not equal to or has not exceeded the maximum number, the CU is rebooted 407 again. If the number of attempts to reboot is equal to or has exceeded the maximum number of attempts, the secondary communication medium, wireless is enabled 410.

### Switching to Wireless Communication Medium

If the STP software blocks the powerline medium for communication due to low cost indicating low BPC number, the communication switches to alternate medium, wireless provided by this invention through the Ethernet switch. The STP software assigns high cost to the powerline modem interface and blocks the respective port and the communication is switched to the wireless interface. In FIG. 4, wireless is enabled 410 by the STP software when the primary communication medium, powerline is blocked as described hereinabove.

### Switching to Powerline Communication Medium

The STP software continues to monitor the status of powerline and switches the communication to it if the number of BPC is above the high threshold limit which is configured as described above.

The status of the CU/WD is configured to sleep 411. The CU/WD is activated as shown by Wake up in the figure and the status of the powerline is checked by measuring the number of the BPC 412. If the powerline is certified as NOK by the STP software, the duration for which the powerline has been in the said state is checked 415. If the state of the powerline in the state with the number of BPC being below the high threshold limit is not equal to or has not exceeded the LONG duration, the CU/WD is configured to be in sleep mode 411. If the powerline as mentioned above has been in the said state for duration equal to or has exceeded the LONG duration, the CU is rebooted 416; the STP software then configures the CU/WD to sleep mode 411.

If the STP software certifies the number of BPC to be OK where the number of BPC is higher than the pre-configured high threshold limit indicating acceptable powerline communications following a noise event that affected powerline communication 405. If the powerline is certified as OK as described hereinabove, the duration for which the powerline has been in the said state is checked. If the powerline has not been in the said state for a LONG duration of time, the state of the CU/WD is configured to sleep 411. If the powerline has been in the said state for duration equal to or has exceeded the LONG duration, the wireless is disabled 414. The STP software assigns low cost to the already blocked powerline modem port, unblocks the powerline modem port and enables powerline communication. The STP software configures the CU/WD to sleep 402.

Although the present invention has been described with particular reference to a specific example, variations and modifications of the present invention can be effected within the spirit and scope of the following claims.

1. A system to provide redundancy and wireless switchover in powerline communication systems, each node in the network of the powerline communication system comprising:
a. a first powerline modem interface connected to a powerline communication network and communicating with a powerline modem interface belonging to an upstream node in the network;
b. a second powerline modem interface connected to the powerline communication network and communicating with a powerline modem interface belonging to a downstream node in the network;
c. a first wireless radio interface connected to a wireless communication network and communicating with a wireless radio belonging to an upstream node in the network;
d. a second wireless radio interface connected to the wireless communication network and communicating with a wireless radio belonging to a downstream node in the network; and
e. an Ethernet switch having at least a dedicated port for each of said first powerline modem interface, said second powerline modem interface, said first wireless radio interface, and said second wireless radio interface.

2. A system to provide redundancy and wireless switchover in powerline communication systems, each node in the network of the powerline
communication system comprising:
a. a first powerline modem interface connected to a powerline communication network and communicating with a powerline modem interface belonging to an upstream node in the network;
b. a second powerline modem interface connected to the powerline communication network and communicating with a powerline modem interface belonging to a downstream node in the network;
c. a central processing unit (CPU) comprising a motherboard housing, a first wireless radio interface connected to a wireless communication network and communicating with a wireless radio interface belonging to an upstream node in the network, and a second wireless radio interface connected to the wireless communication network and communicating with a wireless radio interface belonging a downstream node in the network;
d. an Ethernet switch having at least a dedicated port for each of said first powerline modem interface, said second powerline modem interface, and said CPU.

3. A system to provide redundancy and wireless switchover in powerline communication systems as claimed in claim 1, further comprising a STP software to assign costs to said ports and choose a communication network based on a path with lowest cost.

4. A system to provide redundancy and wireless switchover in powerline communication systems as claimed in claim 1, wherein communication of data and voice is using Internet Protocol (IP).

5. A system to provide redundancy and wireless switchover in powerline communication systems as claimed in claim 1, wherein said system is adapted to provide failover capability in both upstream and downstream directions.

6. A system to provide redundancy and wireless switchover in powerline communication systems as claimed in claim 1, wherein said system is adapted to provide seamless switching between the powerline and wireless communication in real time.

7. A system to provide redundancy and wireless switchover in powerline communication systems as claimed in claim 6, wherein said system achieves seamless switching between powerline and wireless communication by using spanning tree protocol (STP).

8. A system to provide redundancy and wireless switchover in powerline communication systems as claimed in claim 1, wherein the wireless communication protocol is WDS.

9. A system to provide redundancy and wireless switchover in powerline communication systems as claimed in claim 1, wherein the wireless communication protocol is WIMAX.

10. A system to provide redundancy and wireless switchover in powerline communication systems as claimed in claim 1, wherein the wireless communication protocol is WiFi.

11. A method to provide redundancy and wireless switchover in powerline communication systems, comprising the steps of:
downloading CU configuration; checking for availability of said powerline communication; measuring state of said powerline communication by measuring value of a pre-defined parameter; and switching between said powerline communication and an alternate wireless communication based on the state of said powerline communication using a STP software.

12. A method to provide redundancy and wireless switchover in powerline communication systems as claimed in claim 11, wherein availability of powerline communication is checked by a ping utility.

13. A method to provide redundancy and wireless switchover in powerline communication systems as claimed in claim 12, said method further comprising the steps of checking the number of attempts to verify the network availability when the availability of the program is not verified by the ping utility and rebooting: the CU if the number of said attempts equals or exceeds the maximum number (MAX) of pre-configured attempts which are allowed by the SIP software.

14. A method to provide redundancy and wireless switchover in powerline communication systems as claimed in claim 12, said method further comprising the steps of checking the number of attempts to verify the network availability when the availability of the program is not verified by the ping utility and configuring the status of CU/WD to sleep mode if the number of attempts is not equal to or has not exceeded the MAX number.

15. A method to provide redundancy and wireless switchover in powerline communication systems as claimed in claim 13, said method further comprising
the steps of said SIP software checking the status of said reboot, and configuring the status of CU/WD to sleep mode if the Reboot is certified as OK.

16. A method to provide redundancy and wireless switchover in powerline communication systems as claimed in claim 13, said method further comprising the steps of said. STP software checking the status of the said reboot, checking, the number of attempts to perform the said reboot against the maximum number of attempts permissible by said STP software when CU is not rebooted properly, and rebooting CU again if the number of attempts to reboot is not equal to or has not exceeded the maximum number allowed by said SIP software.

17. A method to provide redundancy and wireless switchover in powerline communication systems as claimed in claim 13, said method further comprising the steps of said STP software checking the status of the said reboot, checking the number of attempts to perform the said reboot against the maximum number of attempts permissible by said SIP software, and enabling wireless communication if the number of attempts to reboot is equal to or has exceeded the maximum number allowed by said STP software.

18. A method to provide redundancy and wireless switchover in powerline communication systems as claimed in claim 11, wherein state of the powerline communication is measured based on pre-configurable minimum and maximum threshold values of a pre-defined parameter.

19. A method to provide redundancy and wireless switchover in powerline communication systems as claimed in claim 18, wherein the predefined parameter is bit per carrier (BPC).

20. A method to provide redundancy and wireless switchover in powerline communication systems as claimed in claim 18, wherein the pre-defined
parameter is bit per symbol values (BPS).

21. A method to provide redundancy and wireless switchover in powerline communication systems as claimed in claim 18, said method further comprising the steps of said STP software certifying the state of powerline communication to be OK when the pre-defined parameter value is above the minimum threshold value acceptable by said SIP software, and configuring CU/WD to sleep mode.

22. A method to provide redundancy and wireless switchover powerline communication systems as claimed in claim 18, said method further comprising the steps of said STP software certifying the state of powerline communication to be NOK when the pre-defined parameter value is below the minimum threshold acceptable, said STP software checking the duration for which the powerline has been in the said state wherein the state is measured by the pre-defined parameter value, and configuring CU/WD to sleep mode if the duration of the said state of powerline communication is not equal to or has not exceeded the LONG duration.

23. A method to provide redundancy and wireless switchover in powerline communication systems as claimed in claim 18, said method further comprising the steps of said SIP software certifying the state powerline communication to be NOK when the pre-defined measuring parameter value is below the minimum threshold acceptable, said SIP software checking the duration for which the powerline has been in the said state wherein the state is measured by the predefined parameter value, and enabling wireless communication if the powerline has been in the said state for a duration that is equal to or has exceeded the LONG duration.

24. A method to provide redundancy and wireless switchover in powerline communication systems as claimed in claim 23, wherein wireless communication is enabled through an Ethernet switch.

25. A method to provide redundancy and wireless switchover in powerline communication systems as claimed in claim 24, said method further comprising steps of said STP software assigning high cost to the powerline modem interface and blocking the respective port, and enabling wireless communication.

26. A method to provide redundancy and wireless switchover in powerline communication systems as claimed in claim 25, said method further comprising steps of said STP software continuing to monitor the status of powerline communication and configuring the status of the CUAVD to sleep mode.

27. A method to provide redundancy and wireless switchover in powerline communication systems as claimed in claim 26, said method further comprising the steps of activating CU/WD to “Wake up” mode, said STP software checking the status of powerline, said STP software certifying the state of powerline communication NOK when the pre-defined parameter value is below the maximum threshold value acceptable by said STP software, the duration for which the powerline has been in the said state is not being equal to or not exceeding the LONG duration and said STP software configuring CUAVD to sleep mode.

28. A method to provide redundancy and wireless switchover in powerline communication systems as claimed in claim 26, said method further comprising the steps of activating CU/VD to “Wake up” mode, said STP software checking the status of powerline, and said STP software rebooting CU if the powerline is
NOK and the duration for which the powerline has been in the said state equals or exceeds the LONG duration.

29. A method to provide redundancy and wireless switchover in powerline communication systems as claimed in claim 26, said method further comprising
the steps of said STP software certifying the status of powerline to be OK, checking the duration for which the powerline is in the said state, and configuring CU/WD to sleep mode if the powerline has not been in the said state for a LONG duration of time.

30. A method to provide redundancy and wireless switchover in powerline communication systems as claimed in claim 26, said method further comprising the steps of said STP software certifying the status of powerline to be OK, checking the duration for which the powerline is in the said state, disabling wireless communication, enabling powerline communication and configuring
CUAVD to sleep mode if the powerline has been in said state for a duration that is equal to or exceeded the LONG duration.

31. A method to provide redundancy and wireless switchover in powerline communication systems as claimed in claim 30, wherein powerline communication is enabled through the Ethernet switch.

32. A method to provide redundancy and wireless switchover in powerline communication systems as claimed in claim 31, said method further comprising steps of said STP software assigning low cost to the already blocked powerline modem port, unblock the powerline modem port and enabling powerline communication.

33. A method to provide redundancy and wireless switchover in powerline communication systems as claimed in claim 11, wherein each port of said
Ethernet bridge is assigned an initial cost by the software.

34. A method to provide redundancy and wireless switchover in powerline communication systems as claimed in claim 33, wherein the cost is used by said STP software to switch between interfaces connected to the Ethernet bridge by
selecting the lowest cost path and blocking all other higher cost paths.

35. A method to provide redundancy and wireless switchover in powerline communication systems as claimed in claim 34, wherein the initial cost values for the powerline interfaces are lower than the wireless interfaces to enable communication through powerline.
